(19) United States
(12) Patent Application Publication
(10) Pub. No.: US 2009/0274226 A1
(43) Pub. Date: Nov. 5, 2009

(54) SOUNDING CHANNEL BASED FEEDBACK IN A WIRELESS COMMUNICATION SYSTEM

(75) Inventors: Bishwarup Mondal, Oak Park, IL (US); Amitabha Ghosh, Buffalo Grove, IL (US); Fan Wang, Chicago, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/420,092

(22) Filed: Apr. 8, 2009

Related U.S. Application Data
(60) Provisional application No. 61/050,305, filed on May 5, 2008.

(51) Int. Cl. H04L 27/28; H04B 1/00

(52) U.S. Cl. 375/260; 375/130; 375/E01.001

(57) ABSTRACT

An apparatus and method for providing sounding channel based feedback in an OFDM communication system includes a first step (400) of defining a sounding channel spread out over multiple OFDM symbols within a frame. A next step (402) includes conveying a message to a subscriber station including information about the sounding channel. A next step (404) includes requesting a sounding waveform from the subscriber station. A next step (408) includes sending the sounding waveform from the subscriber station over the multiple OFDM symbols. A next step (410) includes sending a downlink transmission weighted in response to the sounding waveform.

### FIELD OF THE INVENTION

This invention relates to wireless communication systems, and in particular, to a mechanism for providing sounding feedback in a communication system.

### BACKGROUND OF THE INVENTION

In mobile broadband cellular communication systems, there are several physical layer techniques that require a transmitter to be provided with knowledge of the channel response between the transmitter and a receiver. Transmission techniques that make use of the channel response between the transmitter and receiver are called closed-loop transmission techniques. One example of closed-loop transmission is the use of a closed-loop transmit antenna array at the transmitter. A closed loop transmit antenna array is an array of multiple transmit antennas where the signals fed to each antenna are weighted in such a way as to control the characteristics of the transmitted signal energy according to some pre-defined optimization strategy.

Generally, the closed-loop transmit antenna array weights the transmitted antenna signals based on knowledge of the space-frequency channel response between each transmit antenna and each receive antenna and attempts to optimize the characteristics of the received signal processed by the receiving device. For single antenna transmitters, the transmitter can use the knowledge of the channel to pre-equalize the channel so as to reduce or even eliminate the need for complex receive equalization at the receiver. Having knowledge of the channel response at the transmitter can also be used to select the best modulation and coding rate to use when transmitting data to the receiver.

In general, there are two methods for providing a transmitter with knowledge of the channel between each transmit antenna and each receive antenna. This discussion is focused at the downlink of a cellular system where the base station (BS) is the transmitter and a subscriber station (SS) is the receiver.

The first method is based on feedback messages from the SS, where the SS measures the channel response between the BS antennas and the SS antennas and transmits a feedback message back to the BS containing enough information that enables the BS to reconstruct the downlink channel response and perform closed loop transmission. For example, the SS could feedback a quantized version of the downlink channel estimates. These techniques rely on a single OFDM symbol or contiguous OFDM symbols in a sounding zone. As a result, as more subcarriers are occupied by the sounding waveform, the transmit power on each sounding subcarrier decreases, a problem which limits the ability of a base station to use sounding to track the frequency selectivity of edge-of-cell mobile stations.

The second method is based on the reciprocity of the RF channel response in a TDD system. In a static (i.e., zero velocity) TDD system, the RF propagation channel is reciprocal, which means the downlink RF channel matrix (where the matrix refers to the channel gains between each transmit and receive antenna) at a given time-frequency point is simply the matrix transpose of the uplink RF channel matrix at the same time-frequency point. Therefore in a TDD system, a downlink channel response can sometimes be derived from an uplink data transmission if the data transmission includes pilot signals. However, in modern digital communication systems, traffic (such as web browsing) is often asymmetric, meaning that there may not be an uplink transmission associated with each downlink transmission. Or, in a broadband system a typical uplink data transmission may be of a smaller bandwidth than the typical downlink data transmission. These issues can severely degrade the performance of closed loop transmission in systems based on reciprocity.

Accordingly, what is needed is a technique to provide feedback to a BS such that the BS can reconstruct the downlink channel response and perform closed loop transmission. It would also be of benefit to provide a technique to improve signal levels for such feedback.

### BRIEF DESCRIPTION OF THE DRAWINGS

The invention is pointed out with particularity in the appended claims. However, other features of the invention will become more apparent and the invention will be best understood by referring to the following detailed description in conjunction with the accompanying drawings in which:

FIG. 1 shows a block diagram of a system, in accordance with the present invention;

FIG. 2 shows a graphical illustration of one embodiment of the format of the feedback information, in accordance with the present invention;

FIG. 3 shows a graphical illustration of another embodiment of the format of the feedback information, in accordance with the present invention; and

FIG. 4 shows a flow chart illustrating a method, in accordance with the present invention.

Skilled artisans will appreciate that common but well-understood elements that are useful or necessary in a commercially feasible embodiment are typically not depicted or described in order to facilitate a less obstructed view of these various embodiments of the present invention.

### SUMMARY OF THE INVENTION

The present invention comprises of a method to provide a transmitting device with complete or partial knowledge of channel response between one or multiple transmit antennas and one or multiple receive antennas of a receiving device using a sounding subchannel. Applications for this method include obtaining real or complex weights for each transmit antenna based on the information derived from a sounding subchannel, pre-equalization for single antenna systems, determination of a modulation and coding scheme for transmission, determination of frequency bands for future transmission or reception. For the sake of clarity, the invention is presented from the point of view of providing a base-station (BS) with the knowledge of a subscriber station (SS) using a sounding subchannel. It should be clear that the invention equally applies to the scenario where the SS is provided with the knowledge of a BS. Thus a transmitting device can be part of a BS, an SS, a relay, a repeater or any similar device and a sounding subchannel may be used to provide channel information from a receiving device which can be part of a BS, an SS, a relay, a repeater or any similar device.

One aspect of the invention is the definition of a sounding subchannel. A sounding subchannel is a unit of a logical resource for providing the BS with channel response information and this is related to the physical time frequency resources from multiple OFDM symbols by a map. This map may be specific to a particular SS and can change dynamically with time. A part of the map may be common among multiple SS while a part of the map may be customized for a particular SS. A part of the map may be static in time while a part of the map may be changing dynamically. A part of the map may be specific to a particular sector or cell while a part of the map may be common across multiple sectors or cells. The information to specify, determine or characterize a map completely or partially is a set of sounding subchannel parameters. A sounding subchannel defines a unit of logical resource assigned to an SS or a group of SS. Multiple sounding subchannels may be aggregated to form a sounding channel.

One aspect of the invention is a method for using the sounding subchannel to carry a sequence or a set of modulation symbols from the SS to the BS where the sequence or the set of modulation symbols is determined a-priori by the BS and indicated to the SS.

One aspect of the invention is a method for using the sounding subchannel to carry data not modulated as symbols or modulation symbols from the SS to the BS where the data not modulated as symbols or the modulation symbols is unknown to the BS. However, the data not modulated as symbols or the modulation symbols that are unknown to the BS carry channel response information and are distinctly different from regular traffic.

One aspect of the invention is the dynamic existence of a sounding subchannel. The presence or absence of a sounding subchannel in one or multiple frames or subframes is signalled to an SS or a group of SS from the BS implicitly or explicitly periodically or in an aperiodic manner. The indication of the presence or absence of a sounding subchannel may be transmitted aperiodically or periodically once in every superframe or once in each frame or once in each subframe. This information may be broadcast to all users or multicast to a group of users or unicast to a single user. This information may be carried in a superframe header or a unicast control channel.

One aspect of the invention is the signaling of the sounding subchannel parameters from a BS to a SS or a group of SS periodically or in an aperiodic manner. The sounding subchannel parameters comprise of parameters that are common among multiple users, parameters that are semi-static, parameters that are customized to a single user and parameters that dynamically vary with time. Each of these different classes of parameters may be signalled differently and at different intervals for example the semi-static and common parameters may be broadcast in a superframe header while the user-specific parameters may be transmitted in a unicast control channel. The sounding subchannel parameters may indicate the start of a sounding subchannel (in terms of OFDM symbols or subframes), the duration of a sounding subchannel (in terms of the number of OFDM symbols or subframes), the bandwidth and frequency location of occupation of the sounding subchannel, method of multiple access like cyclic shift or decimation, parameters for multiple access like decimation factor and cyclic shift values, identification of the sequence or set of modulation symbols to be carried over the sounding subchannel, indication of the type of data or waveform not modulated as symbols or modulation symbols to be carried over the sounding subchannel like covariance entries or precoding matrices or indices for codebook elements.

One aspect of the invention is a method for multiple access of the sounding subchannel using decimation or cyclic shift in both time and frequency where each SS transmits over multiple OFDM symbols. This may be signalled by sounding subchannel parameters or a bitmap that describes decimation or cyclic shift values over multiple OFDM symbols.

One aspect of the invention is a method for assigning one or more sounding subchannels to multiple SSs (or to different antennas on the same SS) yet is separable at the BS due to the distinguishing properties of the waveform transmitted on the same subchannel. Cyclic shifted sequences may be transmitted by different SSs on the same sounding subchannel to achieve separability at the BS.

One aspect of the invention is a method for assigning a particular sounding subchannel or multiple sounding subchannels to a particular SS or a group of SS or indicating sounding parameters by explicit signaling by the BS to the particular SS or a group of SS.

One aspect of the invention is a method for assigning one or more sounding subchannels to a particular SS or a group of SS or indicating sounding parameters by implicit signaling from the BS to the particular SS or a group of SS. The implicit signaling means that conventional downlink control signals transmitted by the BS carrying information for downlink allocation or uplink grant or downlink reference signals is used to convey the assignment of a particular sounding subchannel or sounding parameters to an SS or a group of SSs.

One aspect of the invention is a method for an SS to substitute or puncture an uplink reference signal by a sounding subchannel or vice-versa in one or more subcarriers in one or more OFDM symbols.

One aspect of the invention is a method for an SS to use rate-matching for uplink data when an uplink allocation coexists with a sounding subchannel in a single resource-tile.

One aspect of the invention is a method for an SS to construct a sounding sequence or a waveform not modulated as symbols or a set of modulation symbols in response to and according to a sounding subchannel assignment by the BS or sounding parameters transmitted from the BS.

One aspect of the invention is a method for boosting the power of a sounding subchannel transmission by an SS according to BS requests.

One aspect of the invention is a method for the BS to use channel response information received from one or more sounding subchannels from multiple SSs in earlier subframes for determining subsequent downlink transmissions to a particular SS.

### DESCRIPTION OF THE PREFERRED EMBODIMENTS

The present invention provides a technique for feedback to a BS such that the BS can reconstruct the downlink channel response and perform closed loop transmission. In addition, the present invention provides a technique to improve signal levels for such feedback. In addition, by reducing the number of sounding carriers within a given sounding symbol, the transmit power on each sounding carrier can be increased significantly, which will improve channel estimation performance at the BS during sounding. Specifically, the present invention constructs a sounding waveform that is distributed in time such that the subcarriers on different frequencies will occur in different OFDM symbols.

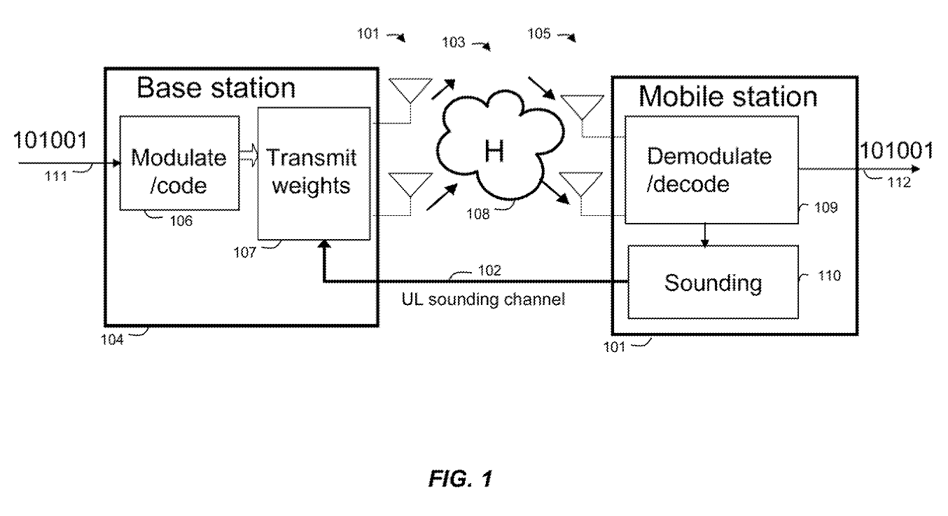

FIG. 1 shows a block diagram of communication system, in accordance with the present invention. The communication system can include a plurality of cells (only one represented) each having a base station (BS, or base station) 104 in communication with one or more subscriber stations (SSs) 101. If closed loop transmission is to be performed on the downlink 103 to SS 101, the BS 104 can be referred to as a source communication unit, and the SS 101 can be referred to as a target communication unit. In the preferred embodiment of the present invention, communication system 100 utilizes an Orthogonal Frequency Division Multiplexed (OFDM) or multicarrier based architecture including Adaptive Modulation and Coding (AMC). The architecture may also include the use of spreading techniques such as multi-carrier CDMA (MC-CDMA), multi-carrier direct sequence CDMA (MC-DS-CDMA), Orthogonal Frequency and Code Division Multiplexing (OFCDM) with one or two dimensional spreading, or may be based on simpler time and/or frequency division multiplexing/multiple access techniques, or a combination of these various techniques. However, in alternate embodiments communication system 100 may utilize other cellular communication system protocols such as, but not limited to, TDMA or direct sequence CDMA.

The BS 104 includes a closed-loop transmit antenna array 101 communicating a single data stream to a SS 101 having one or more receive antennas 105 (e.g., a MIMO system). Input stream 111 is modulated and coded 106 and then multiplied by transmit weights 107 before being fed to the multiple transmit antennas 101. Multiplying the input stream 111 by transmit weights 107, where the transmit weights are based on at least a partial channel response, is one example of tailoring a spatial characteristic of the transmission. Methods for determining the transmit weights from the channel response are known in the art. The signals transmitted from the multiple transmit antennas 101 propagate through a matrix channel 108 and are received by multiple receive antennas 105. The signals received on the multiple receive antennas 105 are demodulated and decoded 109 to produce the output symbol stream 112.

The SS 101 can be instructed by the BS 104 to perform sounding measurements 110 of the channel 108 and provide these sounding measurements through an uplink 102 to the BS 104. The BS 104 can then reconstruct the response of the downlink channel 108 and adjust the transmit weights 107 accordingly to improve the channel response using techniques known in the art.

In the prior art, the sounding symbols (or sequence) transmitted by a particular MS is restricted (such as in WiMAX) to reside in a single OFDM symbol. As a result for cell-edge mobiles, the quality of uplink feedback is severely limited by the peak transmit power of the MS within one OFDM symbol duration. An OFDM symbol may be repeated, but this does not alleviate the problem with peak transmit power. For example, a CQI feedback channel may be used for sounding that enables an MS to use three (such as in WiMAX) consecutive OFDM symbols for sounding. This alone does not enable an MS to sound with more power for each OFDM symbol compared to a single symbol. The reason is that a CQI channel is primarily designed for CQI feedback and is thus robustly coded. Moreover, there is no corresponding signaling to request an MS to use the three OFDM symbols efficiently for sounding purposes. Furthermore, the prior art has a simple control signal design that requests an MS to provide all feedback-related information: typical sounding or analog/digitized feedback, using uplink channel sounding (ULCS).

A novel aspect of the present invention is providing a sounding channel 102 that contains the sounding feedback, but is multiplexed both in time and frequency with other content (i.e. uplink data, pilot signals, etc.) in a manner which is distinct from a sounding zone. In particular, the present invention introduces a new sounding channel 102 (in place of the prior art sounding symbol) that includes sounding subcarriers on multiple OFDM symbols for a single SS, and associated downlink signaling from the BS to enable an SS to efficiently use multiple OFDM symbols for sounding. Advantageously, the present invention allows a cell-edge SS to use multiple OFDM symbols for sounding and can thus use power from multiple OFDM symbol durations. For example, an SS can use two OFDM symbols instead of one and thereby sound with 3 dB more power. In addition, the proposed sounding channel simplifies downlink signaling and enables an SS to use multiple OFDM symbols more efficiently than the CQI channel. Although, the proposed solution of the present invention may imply more power consumption by the SS, a little more feedback delay, and less micro-sleep (up to six OFDM symbols, or around 600 microseconds), this tradeoff can be controlled by the BS as a performance parameter.

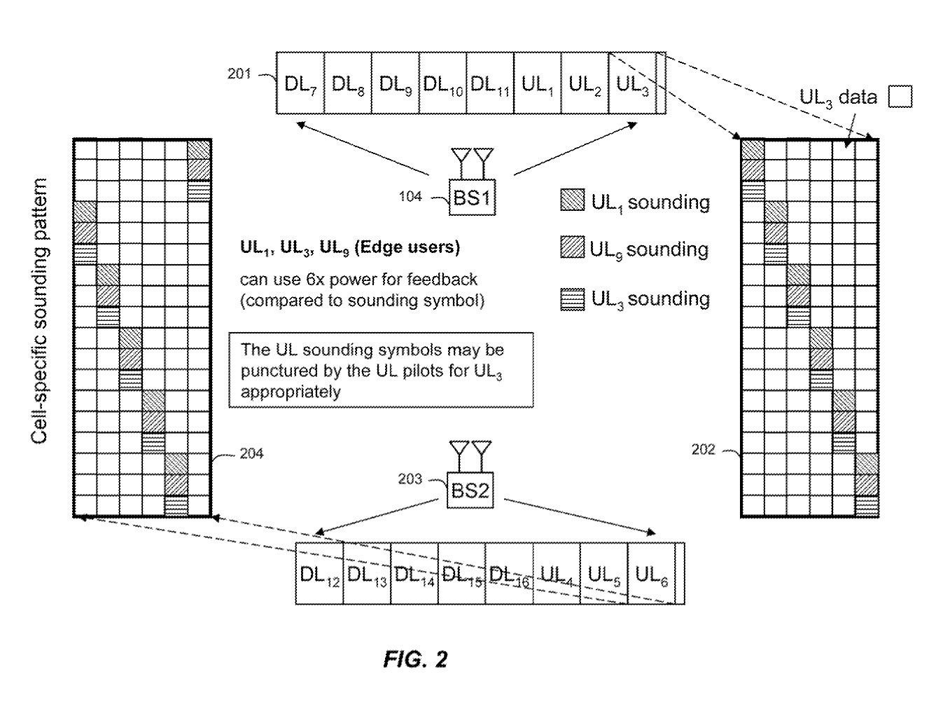

FIG. 2 shows a diagram of UL/DL frames 201 of BS1 104 in a TDD system or an FDD system, and in particular illustrates the physical location for the proposed sounding channel of the present invention with decimation=3 (i.e. functionally similar to UL channel sounding in WiMAX). Both the DL and the UL subframes can occupy the same frequency band. The DL is used for transmissions by the BS, and the UL is used for transmissions by the SS or mobile station. The relative length of the DL frame and the UL frame can be adjusted according to the expected relative levels of DL traffic and UL traffic.

The sounding subchannel is mapped to a resource tile of size 18 subcarriers x 6 OFDM symbols of the uplink subframe (shown here in UL₃) that is dynamically reserved for the transmission of special sounding waveforms by the SSs to enable the BS to measure at least a partial uplink frequency selective channel profile or channel response. To signal both the presence and characteristics of the sounding channel, a special information element (IE) may be transmitted by the BS in the control channel (preferably the UL control channel, which for example in IEEE 802.16 is called the UL-MAP) to one or more served SS. For the purpose of explanation, this IE contains the information that specifies exactly where the sounding channel is located in time and frequency.

Preferably, the IE also contains which specific feedback information is desired from the SS. More preferably, the IE assigns the sounding waveform (or sounding signal) to be used by the SS when sounding on the UL. Note that signaling to specify the sounding channel is not required; however, it can reduce the overhead in the actual sounding assignments made to specific SSs by broadcasting some of the information that is useful for all SSs. The allocated sounding channel can be in any time-frequency portion of the uplink frame. It should be noted that the sounding channel can be omitted from the UL portion of the frame simply by not transmitting the IE. Alternatively, the information in the IE can be transmitted with an indication that some number of the following frames will have a sounding channel having the same characteristics as those being specified in the IE. This would eliminate the need to transmit an IE in the control channel of every frame.

The sounding channel can be scheduled in some but not all of the uplink frames. Preferably, the uplink frames for different base stations have different time-frequency resources allocated to the sounding channel such that the sounding channel placement is non-overlapping between different base stations. The current sounding channel allocation can be signaled to the SSs by updating and transmitting the IE on a frame-by-frame basis. By enabling dynamic reservation of the sounding channel, the BS is able to effectively adapt to different scenarios. Some examples of this are as follows. In one example, the size of the sounding channel is selected based on an expected number of SSs that will need to do sounding in the frame where the sounding channel is being reserved. One aspect influencing this is that the number of active SSs over any time interval can vary, so the size of the sounding channel can be dynamically adjusted accordingly. Also, there may be a mixture of closed loop and open loop transmissions being made by the BS, so the size of the sounding channel may need to change accordingly. To accommodate this and other scenarios while minimizing the overhead of the sounding channel, the size of the sounding channel may be changed from the current frame to the next frame.

In a preferred embodiment for an IEEE 802.16-like system, the sounding channel is constructed as follows. The signaling parameters of the OFDMA mode of the IEEE 802.16 air interface standard are used to provide a detailed example, but the invention is not limited to this particular example. The frequency band is divided into 18 frequency bins, where each frequency bin contains 6 OFDM subcarriers. To construct the frequency portion of the sounding channel, divide the frequency band into 6 sounding frequency blocks, where each block contains 3 frequency bins. In the example shown, each sounding frequency block consists of an UL₁ sounding bin, UL₃ sounding bin, and UL₉ sounding bin. Each frequency block is rotated through a different set of frequency bins per each subcarrier. Of course, it should be recognized that the frequency blocks may be distributed in any patterns as long as the patterns do not overlap between neighboring bases stations, i.e. pattern 202 for UL₃ subframe for BS1 104 does not overlap pattern 204 for UL₆ subframe for BS2 203. Alternatively, different UL frames could be used for different base stations, wherein the different subframes may have the same or a different pattern of sounding frequency blocks.

In practice, the sounding content is multiplexed with other UL data (e.g. UL₃ data as shown). Preferably, rate matching is used for the other UL data to provide room for the sounding content in the subframe without loss of the other UL data. In addition, where sounding content shares a subchannel with a pilot signal, the pilot signal is punctured with the sounding content. More preferably, power boosting is provided for the sounding content over the other UL data.

The sounding channel is allocated some number of OFDMA symbol intervals (also called bauds or OFDM symbol periods) that can vary on a dynamic basis according to the level of traffic that will employ closed loop transmission. According to the above preferred construction guidelines, the sounding channel consists of a two dimensional grid of 6 sounding frequency blocks by some number of sounding bauds that can be dynamically adjusted according to the level of DL traffic that will use closed-loop transmission.

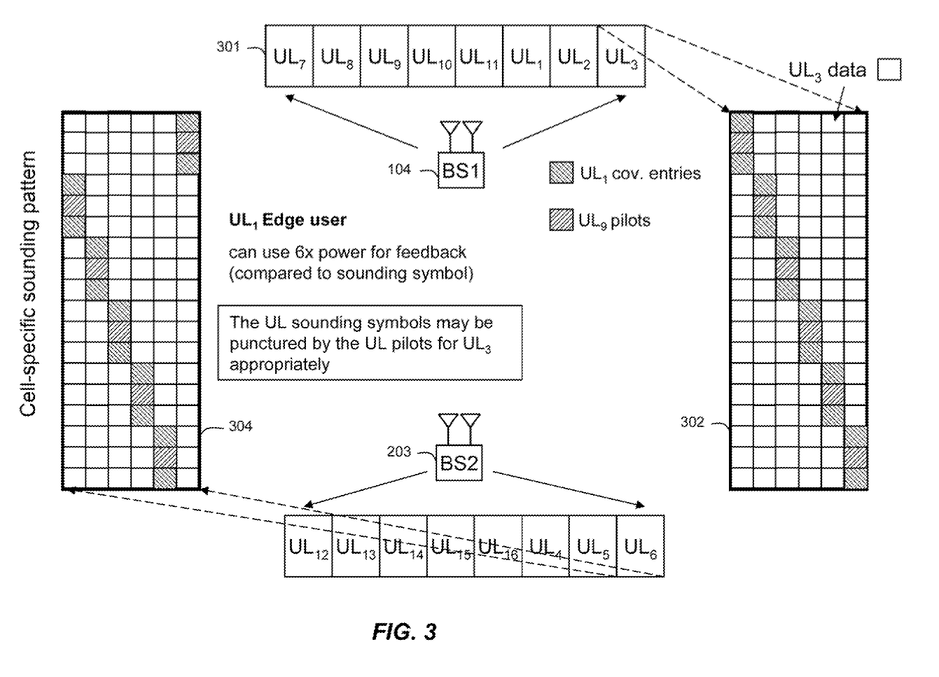

FIG. 3 shows an alternate configuration for the sounding channel operable on UL subframes, in accordance with the present invention. In particular, the physical location for the proposed sounding channel is illustrated for the example of direct covariance feedback. This case is similar to the WiMAX decimation case, with the exception that different sounding content is carried than the previous case. For example, the sounding frequency block consists of UL covariance matrix entries and pilot signals as shown (e.g. a UL₁ covariance matrix entry, a UL₉ pilot signal, and another UL₁ covariance matrix entry). Otherwise, the application of the present invention is the same as before.

Another novel aspect of the present invention is conveying a sounding channel allocation signal from a base station to subscriber stations to tell the subscriber station which portion (sub)frame to use for feedback on the sounding channel. In one embodiment, this conveyance includes the number of subcarriers across multiple OFDM symbols within one subframe. In another embodiment, this conveyance is similar to existing WiMAX decimation which includes; the starting sounding band, the number of continuous sounding bands, the decimation factor, and the decimation offset. However, this embodiment also includes symbol mapping (6 bit) on OFDM symbols allocated for sounding. In yet another embodiment, this conveyance is similar to existing WiMAX decimation which includes; the starting sounding band, the number of continuous sounding bands, and the decimation factor. However in this embodiment, specific tiles for the decimation offset are defined.

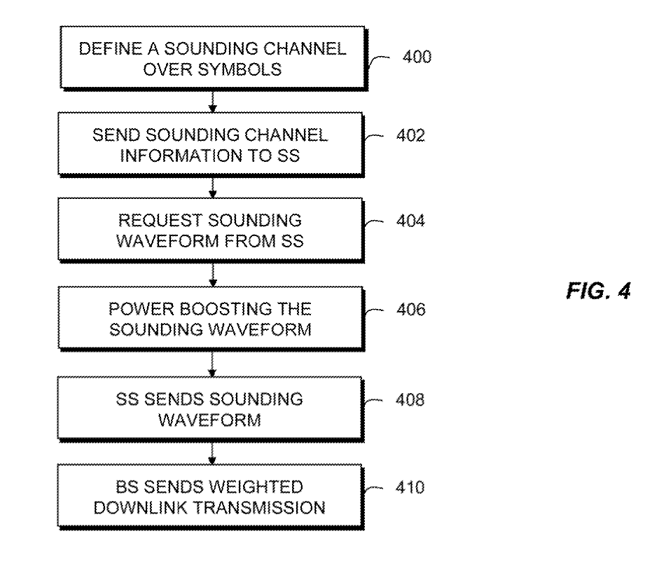

FIG. 4 shows a flowchart that illustrates a method for providing sounding channel based feedback in an OFDM communication system, in accordance with the present invention.

A first step 400 includes defining a sounding channel spread out over multiple OFDM symbols within a frame or subframe. The sounding channel carries the feedback information in the form of a sounding waveform that extends over the multiple OFDM symbols. In particular, the feedback information is multiplexed with the other non-feedback-related UL data. To provide better performance without a loss of the other data, the other data can be rate-matched to accommodate the additional feedback information in the subframe. Where the subframe includes pilot signals, the pilot signals are punctured with the feedback information. Preferably, the sounding channel placement is different between different base stations to provide non-overlapping time-frequency placement of feedback information therebetween.

A next step 402 includes conveying a message to a subscriber station including information about the sounding channel. This message can not only tell the SS where to put the feedback information within a (sub)frame, but can also tell the SS exactly what feedback information content to include in the reply. In one embodiment, this conveyance can include the number of subcarriers across multiple OFDM symbols within one subframe. In another embodiment, this message includes symbol mapping (6 bit) on OFDM symbols allocated for sounding. In yet another embodiment, this message defines specific tiles in the time-frequency space for a decimation offset.

A next step 404 includes requesting a sounding waveform from the subscriber station. This step may be combined with the above step.

A next step 406 includes power boosting the sounding waveform over other UL data.

A next step 408 includes sending the sounding waveform from the subscriber station over the multiple OFDM symbols. In particular, the sounding waveform is distributed in time such that the subcarriers on different frequencies will occur in different OFDM symbols.

A next step 410 includes sending a downlink transmission weighted in response to the sounding waveform.

Advantageously, the present invention provides DL efficient signaling on sounding channel allocation. In particular, the present invention improves the performance of cell-edge users without compromising the performance of other users in the system. The present invention broadens the scope of uplink channel sounding and analog feedback sounding. The present invention improves the performance of direct covariance feedback and is more competitive with codebook feedback for cell-edge users. In addition, the present invention enables additional features for sounding such as cell-specific permutation and power stealing from data. In addition, the interference limited scenario for UL sounding power boosting is avoided.

Although the preferred embodiment of the present invention is described with reference to access networks in a communication system, it will be appreciated that the inventive concepts hereinbefore described are equally applicable to any wired and wireless communication system.

It will be understood that the terms and expressions used herein have the ordinary meaning as is accorded to such terms and expressions by persons skilled in the field of the invention as set forth above except where specific meanings have otherwise been set forth herein.

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

What is claimed is:

1. A method for providing sounding channel based feedback in an OFDM communication system, the method comprising the step of:
defining a sounding channel spread out over multiple OFDM symbols within a frame;
conveying a message to a subscriber station including information about the sounding channel;
requesting a sounding waveform from the subscriber station;
sending the sounding waveform from the subscriber station over the multiple OFDM symbols; and
sending a downlink transmission weighted in response to the sounding waveform.

2. The method of claim 1, wherein the sending step includes sending the sounding waveform distributed in time such that the subcarriers on different frequencies will occur in different OFDM symbols.

3. The method of claim 1, wherein in the defining and sending steps the sounding channel carries feedback information multiplexed with other non-feedback uplink data.

4. The method of claim 3, wherein the other non-feedback uplink data is rate-matched to accommodate the additional feedback information in the subframe.

5. The method of claim 3, wherein if the subframe includes pilot signals, the pilot signals are punctured with the feedback information.

6. The method of claim 1, wherein the defining step includes defining the sounding channel such that the sounding channel placement is different between different base stations to provide non-overlapping placement of feedback information therebetween.

7. The method of claim 1, wherein the conveying step includes placement information within the subframe for feedback information.

8. The method of claim 7, wherein the conveying step further defines what feedback information content to include in the replying step.

9. The method of claim 1, further comprising the step of power boosting the sounding waveform over other UL data.

10. The method of claim 1, wherein the conveying step includes the number of subcarriers across multiple OFDM symbols within one subframe.

11. The method of claim 1, wherein the conveying step includes symbol mapping on OFDM symbols allocated for sounding.

12. The method of claim 1, wherein the conveying step defines specific tiles in the time-frequency space for a decimation offset.

13. An OFDM communication system providing sounding channel based feedback, the communication system comprising:
a base station operable to define a sounding channel spread out over multiple OFDM symbols within a frame, convey a message to a subscriber station including information about the sounding channel, request a sounding waveform from the subscriber station, and send a downlink transmission weighted in response to the sounding waveform; and
a subscriber station operable to send the sounding waveform from the subscriber station over the multiple OFDM symbols as defined by the base station.

14. The system of claim 13, wherein the sounding waveform is distributed in time such that the subcarriers on different frequencies will occur in different OFDM symbols.

15. The system of claim 13, wherein the sounding channel carries feedback information multiplexed with other non-feedback uplink data.

16. The method of claim 15, wherein the subscriber station is operable to rate-match the other non-feedback uplink data to accommodate the additional feedback information in the subframe.

17. The system of claim 15, wherein if the subframe includes pilot signals, the subscriber station is operable to puncture the pilot signals with the feedback information.

18. The system of claim 13, wherein the base station is operable to define the sounding channel such that the sounding channel placement is different between different base stations to provide non-overlapping placement of feedback information therebetween.

19. The system of claim 13, wherein the base station is operable to include placement information within the subframe for feedback information and further define what feedback information content to include in the replying step.

20. The system of claim 13, wherein the subscriber station is further operable to power boost the sounding waveform over other UL data.
